(19) United States
(12) Patent Application Publication
(10) Pub. No.: US 2012/0310770 A1
(43) Pub. Date: Dec. 6, 2012

(54) RECOMMENDATION METHOD AND SYSTEM

(75) Inventors: Fidel Cacheda Seijo, A CORUNA (ES); Victor Manuel Carneiro Diaz, A CORUNA (ES); Breixo Formoso López, A CORUNA (ES); Diego Fernández Iglesias, A CORUNA (ES); Ana María Freire Veiga, A CORUNA (ES)

(73) Assignee: UNIVERSIDADE DA CORUNA (OTRI), A CORUNA (ES)

(21) Appl. No.: 13/483,048

(22) Filed: May 30, 2012

Related U.S. Application Data
(60) Provisional application No. 61/492,206, filed on Jun. 1, 2011.

(51) Int. Cl. G06Q 30/00

(52) U.S. Cl. 705/26.7

(57) ABSTRACT

Disclosed embodiments include a recommendation system and apparatus comprising a tendencies based collaborative filtering method. In a particular embodiment, the Tendencies Based Collaborative Filtering Method (TBCFM) is based on the user mean, the item mean, the user tendency calculated using a User Tendency Calculation Method (UTCM); and the item tendency calculated using a Item Tendency Calculation Method (ITCM).

### CROSS-REFERENCE TO RELATED APPLICATIONS

This application claims the benefit of U.S. Provisional Application No. 61/492,206 filed on 2011 Jun. 1 by the present inventors, which is incorporated herein by reference.

### TECHNICAL FIELD

Disclosed embodiments relate to recommendation methods, systems, and apparatuses. Specifically, they relate to recommendation methods, systems, and apparatuses based on collaborative filtering techniques.

### BACKGROUND

The objective of a recommender system is to use information about users to predict the utility or relevance of a particular item, and use this information to provide personalized recommendations for users. There are two main types of recommendation methods and systems: content-based filtering and collaborative filtering.

Content-based methods, such as the one disclosed in U.S. Pat. No. 7,373,318, select the items to recommend based on their content. These methods are usually limited to items that could be analyzed by a machine. Consequently, such systems are difficult to implement in situations that require retrieving multimedia information where machine perception of the content (colors, textures, etc.) differs greatly from user perception. Furthermore, content-based filtering cannot evaluate the quality of an item nor can find serendipitous items (i.e., recommended items that are not apparently related to the user profile). Consequently, content-based methods are inappropriate for recommending either items to users based on the quality or multimedia items.

Collaborative filtering methods are not based on the content of items but rather on the opinions of other users. These methods recommend items that have received high ratings by other users with similar tastes or interests. In these techniques, the items are actually rated by people. Consequently, the system does not need to analyze content (and, therefore, they can be implemented for any type of item including non-annotated multimedia content), and the quality or subjective evaluation of the items is also considered. User ratings are stored in a table known as the rating matrix. This table is processed in order to generate the recommendations. Depending on how the data of the rating matrix are processed, two types of methods, memory-based and model-based, can be differentiated. Memory-based methods, such as the one disclosed U.S. patent application Ser. No. 10/333,953, use the whole table to compute their prediction. Generally, they use similarity measures to select users (or items) that are similar to the active user. Then, the prediction is calculated from the ratings of these neighbors. Memory-based methods are simpler and obtain reasonably accurate results. However, they present serious scalability problems given that the method has to process all the data to compute a single prediction. With a high number of users or items, these methods are not appropriate for online systems which require real-time recommendations.

Model-based methods, such as the one disclosed U.S. patent application Ser. No. 12/347,958, first construct a model to represent the behavior of the users and, therefore, to predict their ratings. The parameters of the model are estimated offline using the data from the rating matrix. These methods tend to be faster in prediction time than the memory-based approaches. However, model-based methods still present several problems. The models can be extremely complex, as they have a multitude of parameters to estimate, and they can be too sensitive to data changes. Additionally, the assumptions of the model may not fit the data, leading to wrong recommendations. In practice, many theoretical models cannot be applied to real data. Moreover, model construction (and update, when new data are added) usually takes a long time for practical applications.

In general terms, collaborative filtering methods are based on the similarities among users or items. Although many different techniques have been used to process the data, most focus on finding more or less hidden relationships. The idea is that, if two users show a similar rating pattern, they will probably coincide in the missing ratings, too. However, to find these relationships, most techniques require a significant amount of information. Therefore, with sparse datasets, these similarity-based methods face serious problems. Currently, there is a need for methods, apparatuses, and systems able to provide high recommendation quality while retaining scalability and computational efficiency.

### SUMMARY

Disclosed embodiments include a method for recommending one or more items among a plurality of items to a user implemented in a recommendation system including a processor and a memory, the method comprising the steps of: (a) calculating a user profile based on a plurality of previous ratings provided by the user; (b) calculating an item profile based on a plurality of previous ratings provided by a plurality of other users; (c) calculating an estimated rating for an item not rated by the user; and (d) calculating a recommendation of one or more items to said user based on said user profile, said item profile, and said estimated rating. According to one embodiment, the recommendation system includes a tendencies based collaborative filtering method. In a particular embodiment, the Tendencies Based Collaborative Filtering Method (TBCFM) is based on the user mean, the item mean, the user tendency calculated using a User Tendency Calculation Method (UTCM); and the item tendency calculated using a Item Tendency Calculation Method (ITCM).

### BRIEF DESCRIPTION OF THE DRAWINGS

Disclosed embodiments are illustrated by way of example, and not by way of limitation, in the figures of the accompanying drawings.

FIG. 1 illustrates a block diagram describing components of an embodiment of a general recommendation system based on collaborative filtering.

FIG. 2 illustrates a detailed block diagram describing an embodiment of the collaborative filtering recommendation method.

FIG. 3 illustrates a block diagram representing an embodiment of the Tendencies Based Collaborative Filtering Method (TBCFM).

FIG. 4 illustrates an embodiment for the Tendencies Based Collaborative Filtering Method (TBCFM).

FIG. 5 illustrates the different scenarios of the Tendencies Based Collaborative Filtering Method (TBCFM) for a particular embodiment.

FIG. 6 illustrates the Mean Absolute Error (MAE) for a particular embodiment using the MovieLens dataset.

FIG. 7 illustrates the coverage and Root Mean Squared Error (RMSE) for a particular embodiment using the MovieLens dataset.

FIG. 8 illustrates the Mean Absolute Error (MAE) and coverage for a particular embodiment using the Netflix dataset.

FIG. 9 illustrates the Mean Absolute Error (MAE) and coverage for a particular embodiment using the MovieLens dataset for the Given-N strategy.

FIG. 10 illustrates the Mean Absolute Error (MAE) and coverage for a particular embodiment using the Netflix dataset for the Given-N strategy.

FIG. 11 illustrates the classification accuracy metrics for a particular embodiment for both MovieLens and Netflix datasets.

FIG. 12 illustrates the computational efficiency for a particular embodiment.

FIG. 13 illustrates the training and evaluation times for a particular embodiment using the MovieLens dataset.

### DETAILED DESCRIPTION

### A. Overall System Components

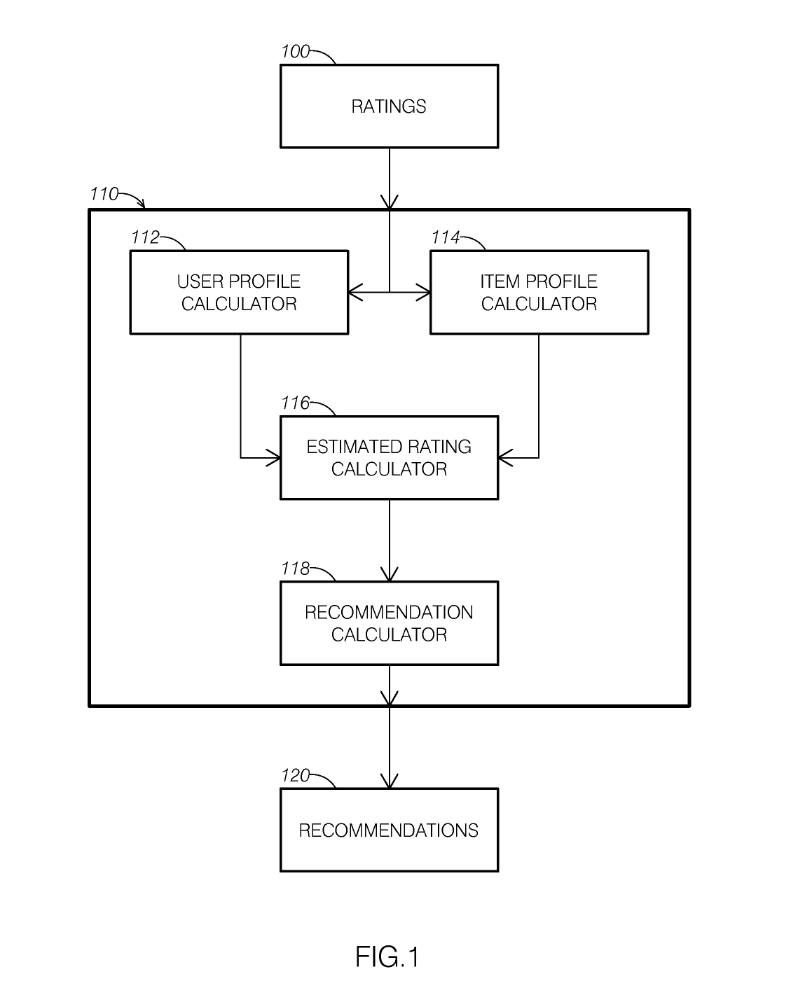

According to one embodiment, as shown in FIG. 1, the recommendation system based on collaborative filtering comprises a processor for computation and memory to store a plurality of ratings 100, a user profile calculator for calculating a user profile based on a plurality of previous ratings provided by a user 112, an item profile calculator for calculating an item profile based on a plurality of previous ratings provided by a plurality of users 114, an estimated rating calculator for calculating an estimated rating for an item not rated by a user 116, a recommendation calculator for calculating a recommendation of one or more items to a user 118, and an interface to report the recommendation results 120.

Certain specific details are set forth in the following description and figures to provide a thorough understanding of various embodiments disclosed. Certain well-known details often associated with computing hardware, processing, and software technology are not set forth in the following disclosure to avoid unnecessarily obscuring the various disclosed embodiments. Further, those of ordinary skill in the relevant art will understand that they can practice other embodiments without one or more of the details described below. Aspects of the disclosed embodiments may be implemented in the general context of computer-executable instructions, such as program modules, being executed by a computer, computer server, or device containing a processor and memory. Generally, program modules include routines, programs, objects, components, and data structures that perform particular tasks or implement particular abstract data types. Aspects of the disclosed embodiments may also be practiced in distributed computing environments where tasks are performed by remote processing devices that are linked through a communications network. In a distributed computing environment, program modules may be located in both local and remote storage media including memory storage devices. Alternatively, according to an embodiment the methods disclosed can be implemented in hardware using an integrated microcontroller or FPGA device to create a recommendation apparatus or systems. Those skilled in the art will appreciate that, given the description of the modules comprising the disclosed embodiments provided in this specification, it is a routine matter to provide working systems that will work on a variety of known and commonly available technologies capable of incorporating the features described herein.

### B. Collaborative Filtering Recommendation Method

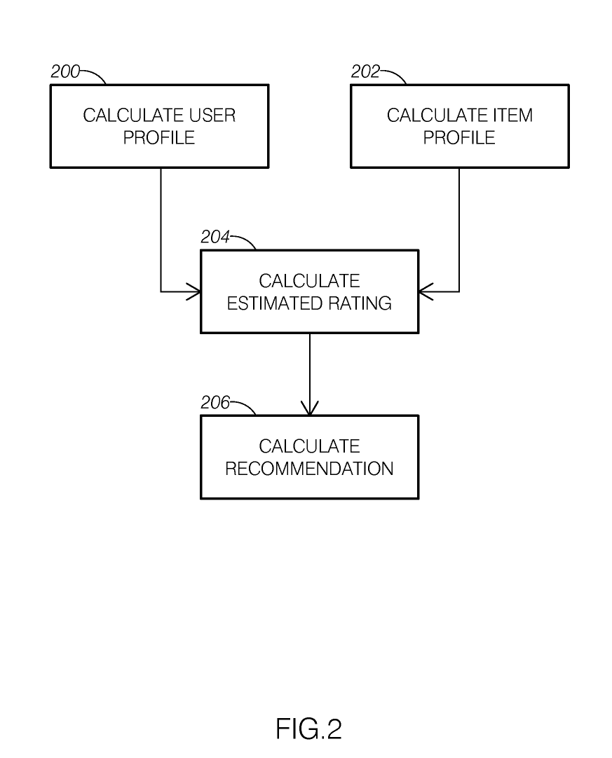

According to one embodiment, as shown in FIG. 2, a computer-implemented collaborative filtering recommendation method for recommending one or more items among a plurality of items to a user, comprises the steps of: calculating a user profile based on a plurality of previous ratings provided by said user 200, calculating an item profile based on a plurality of previous ratings provided by a plurality of other users 202, calculating an estimated rating for an item not rated by said user 204, and calculating a recommendation of one or more items to said user 206.

### B.1. User Profile

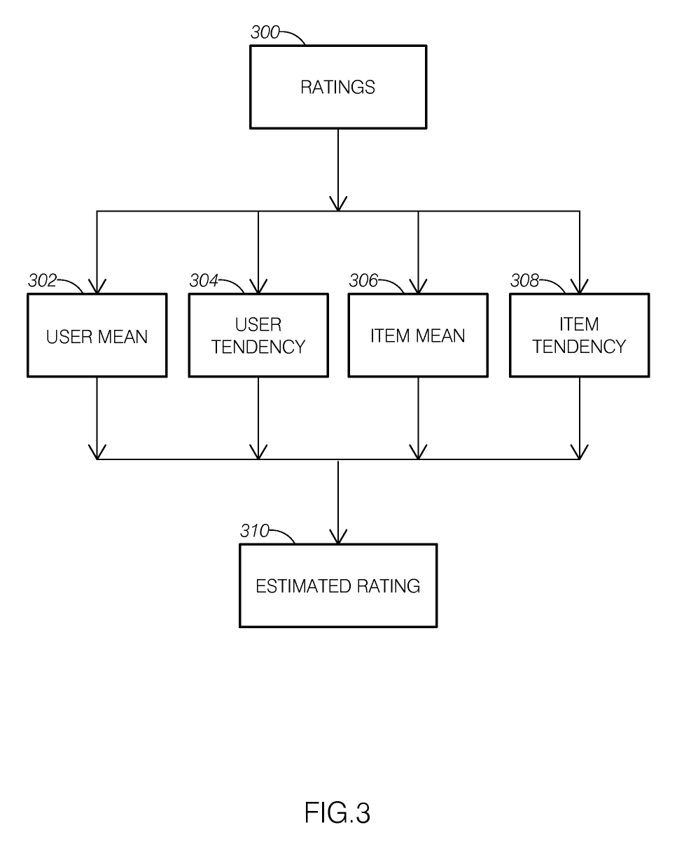

According to one embodiment, as shown in FIG. 3, the user profile is calculated using a mean of said ratings previously provided by said user 300, named user mean 302. The user mean (v_{u.}) is calculated as:

$${v}_{u .} = \frac{{\sum }_{i ∈ {I}_{u}} {v}_{ui}}{\vert {I}_{u} \vert}$$

where vᵤᵢ is the rating of the user u for the item i and Iᵤ is the set of items rated by user u. According to one embodiment, as shown in FIG. 3, the user profile further comprises calculating a tendency of said ratings previously provided by said user, named user tendency 304. The user tendency of said ratings previously provided by said user is calculated using a User Tendency Calculation Method (UTCM). The user tendency (τ_{u.}) is calculated using the UTCM as follows:

$${τ}_{u .} = \frac{{\sum }_{i ∈ {I}_{u}} ( {v}_{ui} - {v}_{. i} )}{\vert {I}_{u} \vert}$$

where v_{.i} is the item mean. Therefore, the user tendency is defined as the average difference between his/her ratings and the item mean.

### B.2. Item Profile

According to one embodiment, as shown in FIG. 3, the item profile is calculated using a mean of said ratings previously provided by said other users 300, named item mean 306. The item mean (v_{.i}) is calculated as:

$${v}_{. i} = \frac{{\sum }_{u ∈ {U}_{i}} {v}_{ui}}{\vert {U}_{i} \vert}$$

where Uᵢ is the set of users who rated the item i. According to one embodiment, as shown in FIG. 3, the item profile further comprises calculating a tendency of said ratings previously provided by said other users, named item tendency 308. Said item tendency of said ratings previously provided by said other users is calculated using an Item Tendency Calculation Method (ITCM). The item tendency (τ_{.i}) is calculated using the ITCM as follows:

$${τ}_{. i} = \frac{{\sum }_{u ∈ {U}_{i}} ( {v}_{ui} - {v}_{u .} )}{\vert {U}_{i} \vert}$$

where v_{u.} is the user mean. Therefore, the item tendency is defined as the average difference between the item rating provided by a user and the user mean.

### B.3. Tendencies Based Collaborative Filtering Method

According to one particular embodiment, the Tendencies Based Collaborative Filtering Method (TBCFM) takes into account the user mean and the item mean as well as their respective tendencies when computing a prediction for a rating, named estimated rating 422.

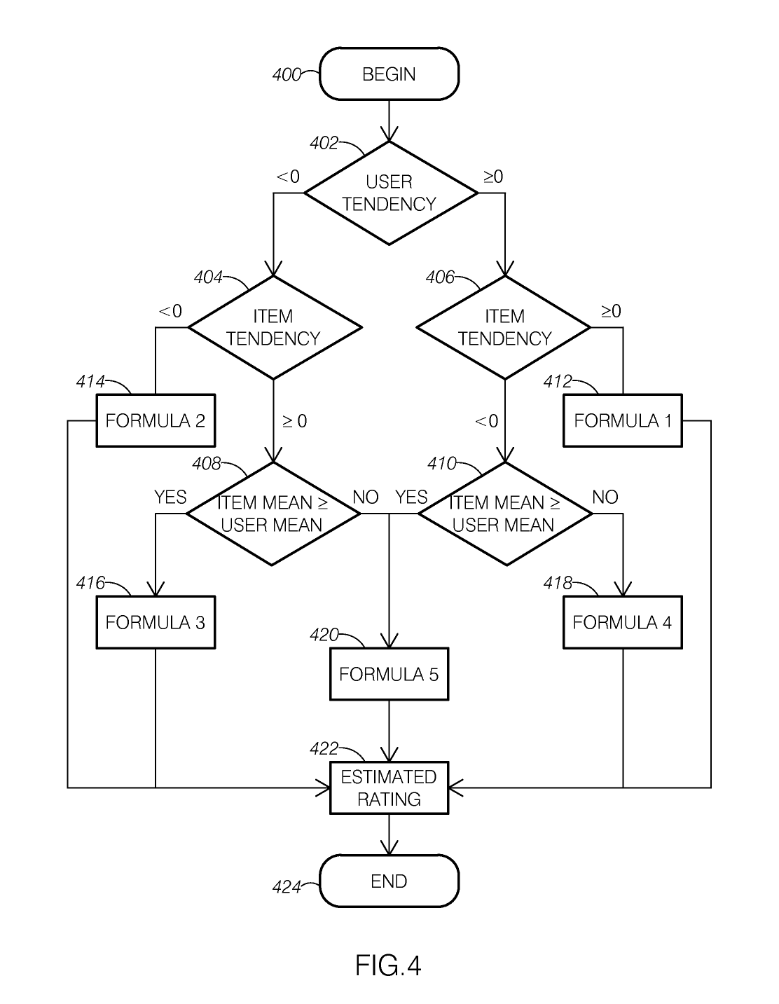

The TBCFM is shown in FIG. 4. If the user tendency and the item tendency are both greater or equal than zero then the estimated rating for a user u and an item i, named pᵤᵢ, is calculated using the Formula 1 412:

pᵤᵢ=max{v_{u.}+τ_{.i},v_{.i}+τ_{u.}} (1)

If the user tendency and the item tendency are both less than zero then the estimated rating is calculated using the Formula 2 414:

pᵤᵢ=min{v_{u.}τ_{.i},v_{.i}+τ_{u.}} (2)

If the user tendency is less than zero and the item tendency is greater or equal than zero and the item mean is greater or equal than the user mean then the estimated rating is calculated using the Formula 3 416:

pᵤᵢ=min{max{v_{u.},(v_{.i}+τ_{u.})β+(v_{u.}+τ_{.i})(1−β)},v_{.i}} (3)

where β is a parameter that controls the contribution of the item and user mean. Possible values range from 0 to 1. In a particular embodiment, and without limitation, β is set to 0.6.

If the user tendency is greater or equal than zero and the item tendency is less than zero and the item mean is less than the user mean then the estimated rating is calculated using the Formula 4 418:

pᵤᵢ=min{max{v_{.i},(v_{.i}+τ_{u.})β+(v_{u.}+τ_{.i})(1−β)},v_{u.}} (4)

Otherwise, the estimated rating is calculated using the Formula 5 420:

pᵤᵢ=v_{.i}β+v_{u.}(1−β) (5)

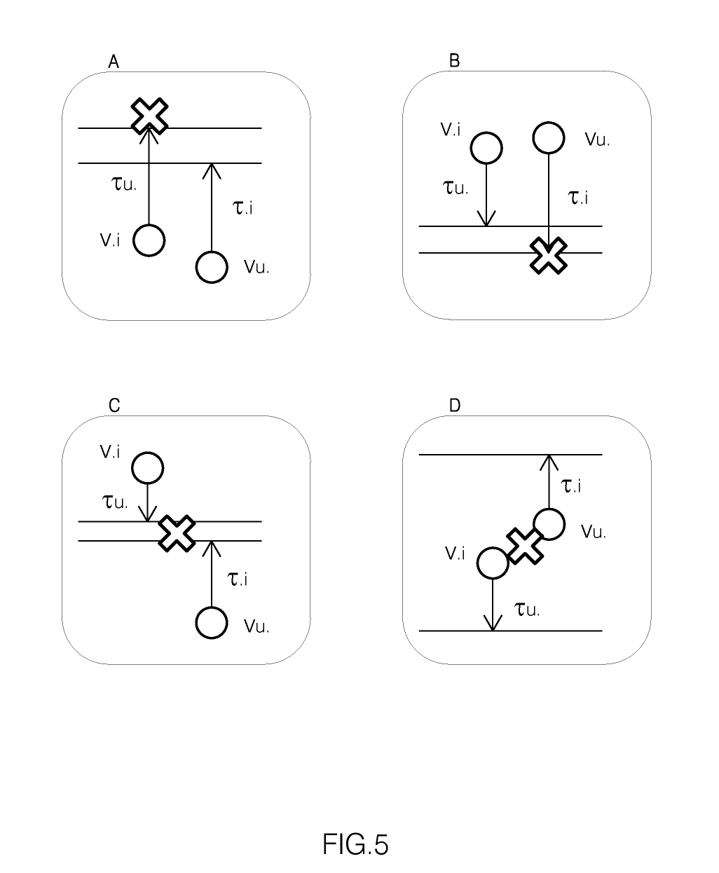

According to another embodiment, FIG. 5 illustrates, graphically, the different scenarios when predicting the value of a rating with the TBCFM. In the first case, FIG. 5(A), both the user and the item have a positive tendency, that is, the user tends to give ratings that are above the item mean rating and the item tends to be rated above the user mean. Therefore, it is appropriate to predict a rating that is above both means (i.e. Formula 1). The second case, FIG. 5(B), is just the opposite. Both the user and the item have a negative tendency. In other words, the user usually rates items below their mean and the item tends to be rated below the user mean (i.e. Formula 2). The third case, FIG. 5(C), occurs in situations involving a negative user (his/her tendency is to rate items below their mean), and a good item (its tendency is to be rated above the user mean), or viceversa. If both means corroborate their tendencies (that is, user with low mean and item with high mean), the prediction will be somewhere in the middle between the two, closer to one or another, depending on the value of the different tendencies (i.e., Formula 3 and Formula 4). Finally, there could be a situation where the means do not corroborate the tendency, FIG. 5(D). This happens when a user with negative tendency rates an item with low mean (the prediction should be bad) but, at the same time, user mean is high and the tendency of the item is positive (which would indicate a good rating) (i.e. Formula 5).

Disclosed embodiments can be implemented in a recommendation apparatus or system for recommending one or more items among a plurality of items to a user. Such apparatus or system comprises: (a) a memory to store a plurality of ratings; and (b) a processor configured for (1) calculating a user profile based on a plurality of previous ratings provided by the user; (2) calculating an item profile based on a plurality of previous ratings provided by a plurality of other users; (3) calculating an estimated rating for an item not rated by the user; and (4) calculating a recommendation of one or more items to the user based on the user profile, the item profile, and the estimated rating. Furthermore, the processor can be configured to execute any of the above described methods, transforming it to a particular and specific recommendation machine that solves a particular and specific problem, namely, a machine for providing recommendations. In particular embodiments, and without limitation, the calculating a user profile is based on computing a mean of the previous ratings provided by the user; calculating an item profile is based on computing a mean of the previous ratings provided by the plurality of other users; calculating an user profile comprises computing a tendency of the previous ratings provided by the user; the calculating an item profile comprises computing a tendency of the previous ratings provided by the plurality of other users; the tendency of the previous ratings provided by the plurality of other users is calculated using a User Tendency Calculation Method (UTCM); the tendency of the previous ratings provided by the plurality of other users is calculated using an Item Tendency Calculation Method (ITCM); and the calculating an estimated rating for an item not rated by the user is calculated using a Tendencies Based Collaborative Filtering Method (TBCFM). Furthermore, in particular embodiments, the recommendation of one or more items to the user comprises the steps of: (a) calculating a plurality of estimated ratings for a plurality of items not rated by the user; (b) sorting the items not rated by the user according to the estimated ratings; and (c) selecting and reporting the items with the estimated rating above a threshold. More specifically, and without limitation, acceding to one particular embodiment the TBCFM comprises (a) calculating a user rating pᵤᵢ, based on a user mean v_{u.}, a user tendency τ_{u.}, an item mean v_{.i}, and an item tendency τ_{.i}, according to pᵤᵢ=max {v_{u.}+τ_{.i},v_{.i}+τ_{u.}} if the user tendency and the item tendency are both greater or equal than zero; (b) calculating the user rating as pᵤᵢ=min {v_{u.}+τ_{.i},v_{.i}+τ_{u.}} if the user tendency and the item tendency are both less than zero; (c) calculating the user rating as pᵤᵢ=min {max{v_{u.}, (v_{.i}+τ_{u.})β+(v_{u.}+τ_{.i})(1−β)}, v_{.i}} if the user tendency is less than zero and the item tendency is greater or equal than zero and the item mean is greater or equal than the user mean; and (d) calculating a user rating as pᵤᵢ=min {max{v_{.i}, (v_{.i}+τ_{u.})β+(v_{u.}+τ_{.i})(1−β)}, v_{u.}} if the user tendency is greater or equal than zero and the item tendency is less than zero and the item mean is less than the user mean or as pᵤᵢ=v_{.i}β+v_{u.}(1−β) in all other cases.

Similarly, the disclosed methods can be embodied in a non-transitory computer-readable storage medium with an executable program stored thereon to implement a recommendation system, wherein the executable program instructs an apparatus to perform the following steps: (a) calculating a user profile based on a plurality of previous ratings provided by the user; (b) calculating an item profile based on a plurality of previous ratings provided by a plurality of other users; (c) calculating an estimated rating for an item not rated by the user; and (d) calculating a recommendation of one or more items to the user based on the user profile, the item profile, and the estimated rating. The specific methods described above can be incorporated and embodied in this non-transitory computer-readable storage medium.

While particular embodiments have been described, it is understood that, after learning the teachings contained in this disclosure, modifications and generalizations will be apparent to those skilled in the art without departing from the spirit of the disclosed embodiments. It is noted that the foregoing examples have been provided merely for the purpose of explanation and are in no way to be construed as limiting. While the method, apparatus, and system has been described with reference to various embodiments, it is understood that the words which have been used herein are words of description and illustration, rather than words of limitations. Further, although the system has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

### C. Experiments

According to one particular embodiment, the Tendencies Based Collaborative Filtering Method was evaluated using two datasets in order to demonstrate its utility and performance compared to other methods. The databases used were MovieLens and Netflix. These are the most popular datasets used by researchers and developers in the field of collaborative filtering.

### C.1. Methodology

The experiments were performed by dividing the dataset into two groups, a training subset and an evaluation subset. The first set corresponds to data the method already knows, that is, the data used to train the method model. With such information, the method computes the recommendation that will be later compared with the original data present in the evaluation subset. Two different approaches have been followed for selecting the training subset. In the first, it is constructed from a percentage of the available ratings, randomly chosen. For the tests all the following percentages were used: 10%, 20%, 30%, 40%, 50%, 60%, 70%, 80%, and 90%. The evaluation subset was composed by randomly selecting 10% of the dataset. The ratings that appear in the evaluation subset were never included in the training subset. With high percentages of ratings in the training set, the behavior of the method under relatively high density conditions can be evaluated. In contrast, a small percentage allows evaluating the method under sparsity conditions, common in the initial phases, or in domains with a large number of users and/or items. In fact, given that many systems operate under these conditions, a second strategy was used to evaluate methods under sparsity conditions. It consists in selecting as training set, a fixed number, generally low, of ratings from each user: 1, 2, 3, 4, 5, 7, 10, 12, 15, and 20 ratings. This strategy is named Given-N.

The two most common tasks of recommender systems were evaluated: the prediction of the item rating and the recommendation of a certain number of items (5, 10, 15, 25, 50, 100, and 150 items were considered). In this second case, there is a challenge inherent to the use of offline datasets: real ratings are not available for most items. In these cases, small errors related to the items rated, like including an item with low rating or leaving out one with a high score, greatly affect the final result. To minimize this problem, in the evaluation, the method was forced to recommend items that have a rating in the evaluation set. Therefore, the final list will consist of N items that were already rated. In the task of annotation in context, this problem is smaller. As long as there is a significant amount of evaluation data, the results can be extrapolated to all the items.

### C.2. Methods

A set of methods representative of the different techniques found in the literature was evaluated for comparison. These include:
Memory-based: User-based (UB), Item-based (IB), Similarity fusion (SF)
Model-based: Regression-based (RB), Slope one (SO), LSI/SVD (SVD), Regularized SVD (variants RSVD, RSVD2, NSVD2 and SVD++), Integrated neighbor-based—SVD model (IM), Cluster-based smoothing (CBS)
item Mixed: Personality diagnosis (PD)

All have been compared with the Tendencies Based Collaborative Filtering Method represented as TB in the figures.

### C.3. Assessment Results

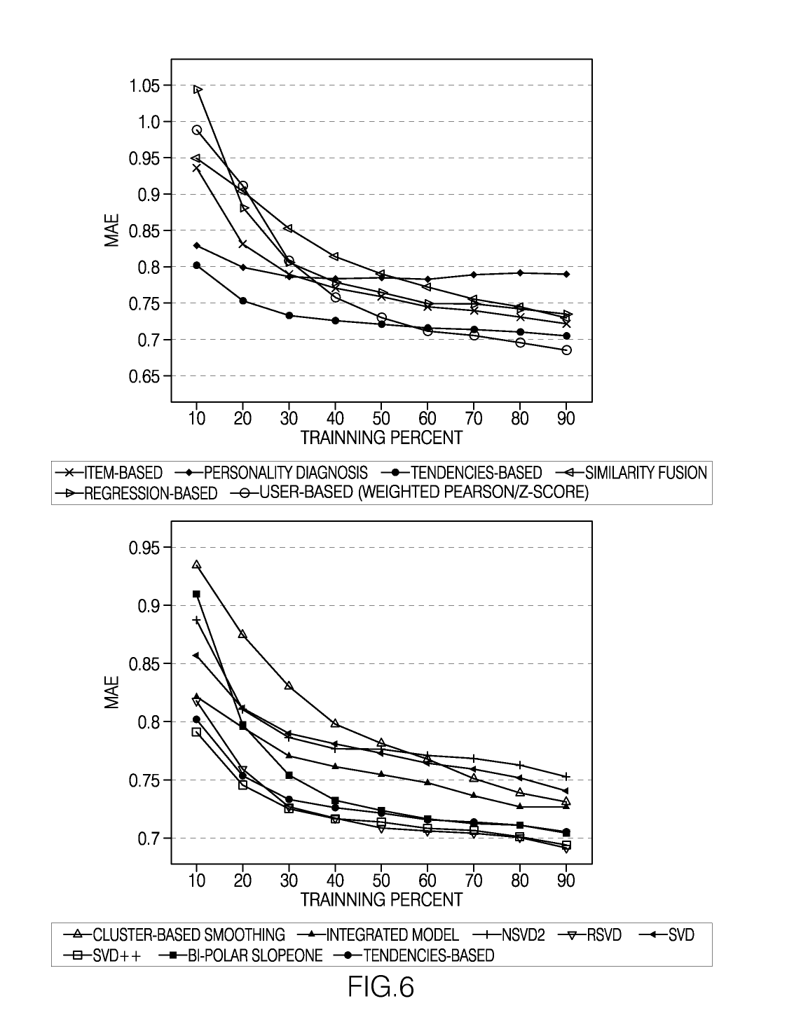

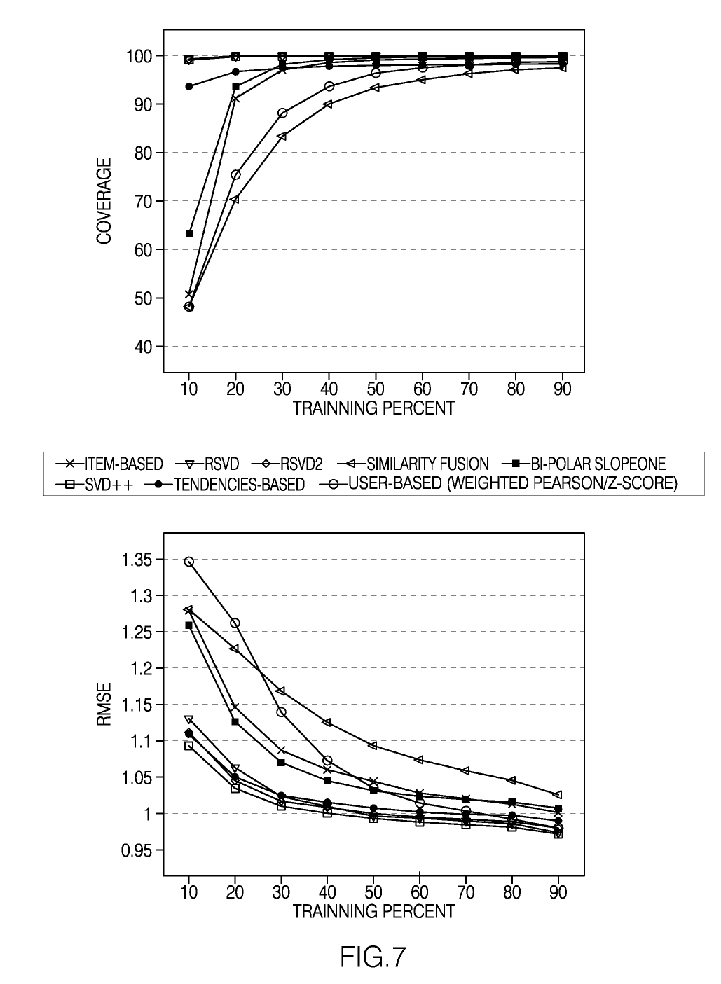

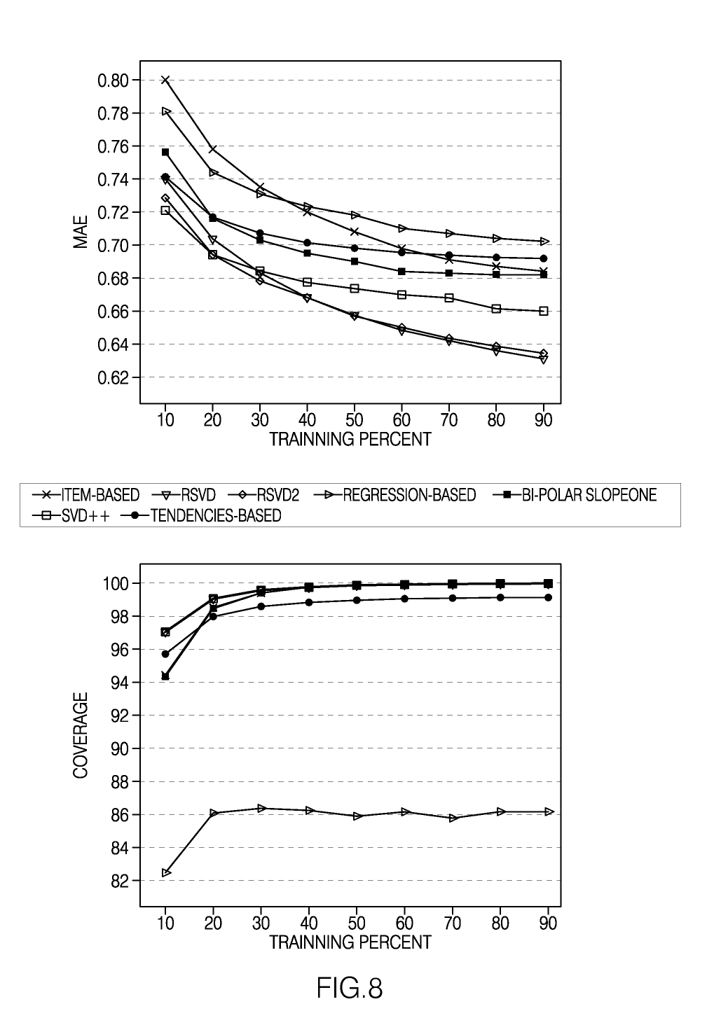

First, the evolution of the accuracy and coverage of the different methods was studied, as the percentage of data used as training set was changed. The results for MovieLens dataset are shown in FIGS. 6 and 7, while those for Netflix are shown in FIG. 8. As observed, all the methods improve as this percentage increases. This behavior is just as expected; by increasing the percentage of data in the training set, the density of the rating matrix increases and, therefore, the method has more information to compute the prediction.

Similarly, as the density of the information increases, a slight decrease in the differences among methods is observed. Most of them present similar results under relatively high density conditions, while their differences are accentuated as density diminishes. In fact, for MovieLens dataset and with a training set of 80%, there is no statistical significance in the MAE differences among the six best methods (UB, RSVD2, SVD++, RSVD, SO and TB), while with 10%, only the three best methods (RSVD2, SVD++, TB) present equivalent results. The same conclusion can be reached from results using the Netflix dataset. With 80% training set, no statistically significant differences exist among the best methods (RSVD, RSVD2, SVD++, SO and TB), while with 10%, SVD++ presents the best results, followed by RSVD2, NSDV2, RSVD and TB.

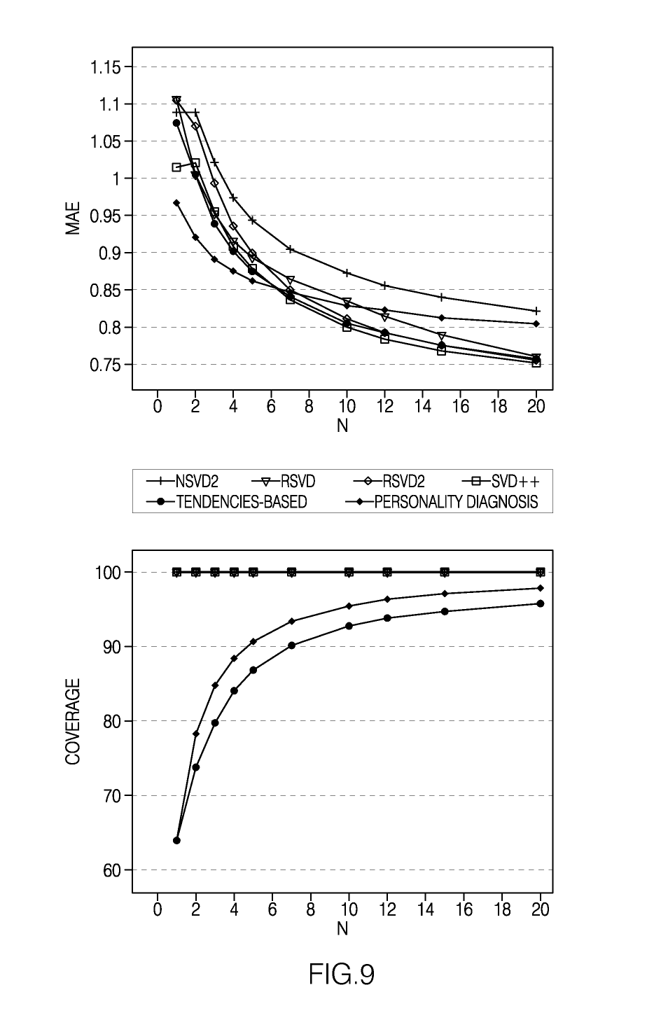

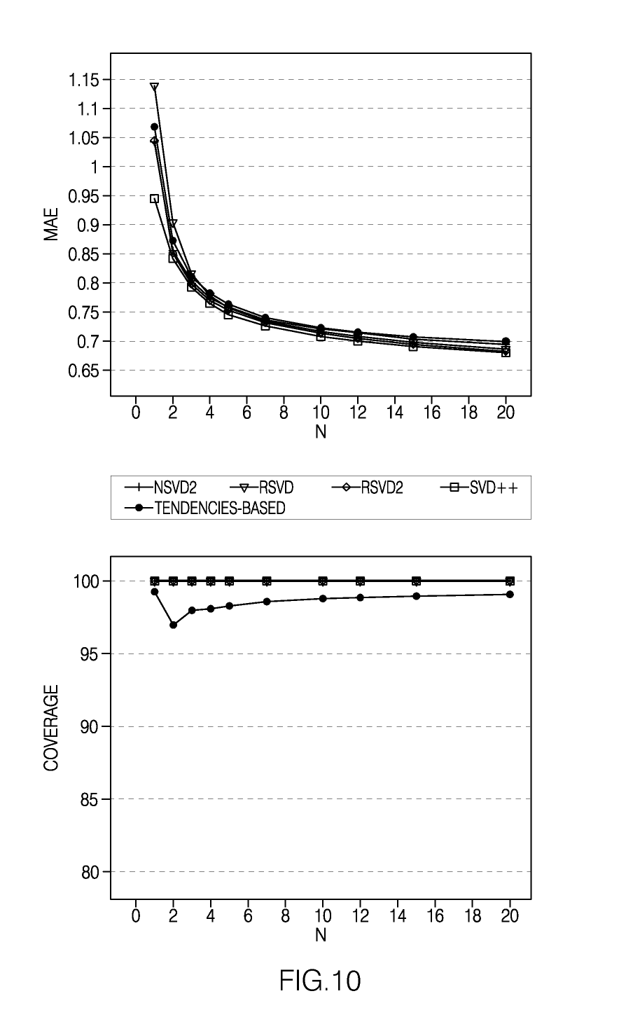

The tests under sparsity environments are good indicators of the ability of methods to extract more information from the rating matrix. As stated previously, the Given-N strategy was used to evaluate the methods under such conditions. Results for MovieLens and Netflix datasets are presented in FIGS. 9 and 10, respectively. For the sake of clarity, only the results for the best methods are shown.

Comparing FIGS. 6, 7, 8, 9, and 10, it is clear how the evolution of accuracy as the matrix density increases is different for each method. This evolution characterizes a technique better than any accuracy measure under specific conditions. Consequently, more than their accuracy, what differentiates the methods is their ability to extract information.

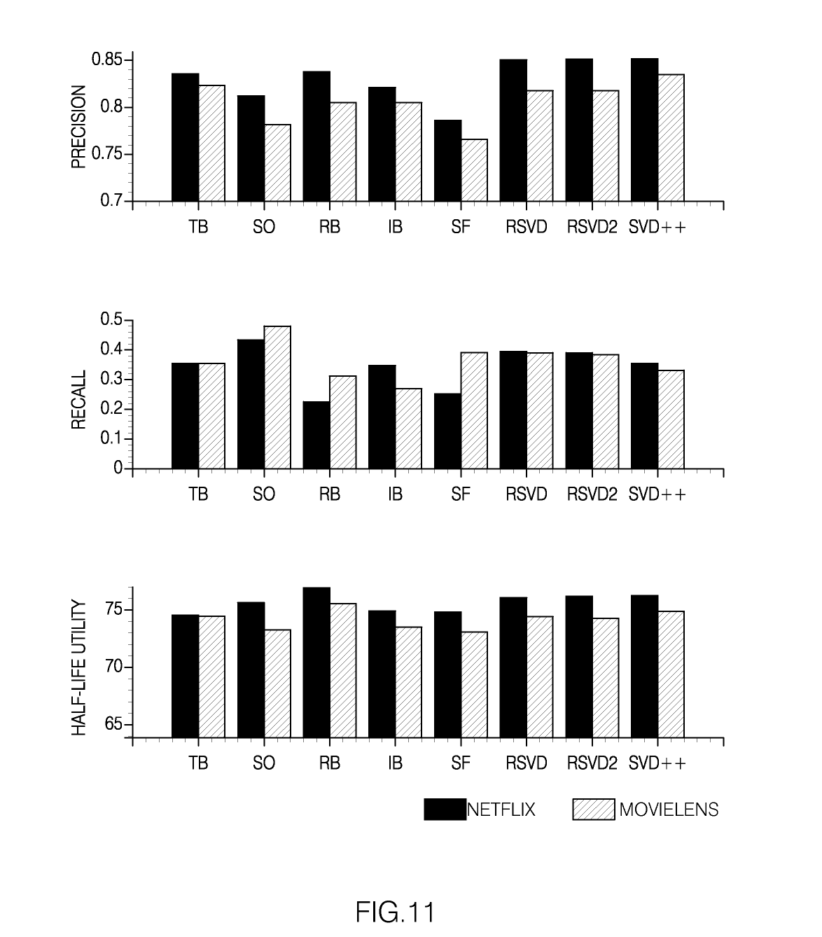

As seen in FIGS. 6, 7, 8, 9, 10, and 11, the tendencies based method is, together with some SVD variants, the one that obtains the best results. Under high density conditions, it is as accurate as the best method, hardly being surpassed in MAE by some memory-based or SVD-based approaches. In fact, in most cases there are no statistically significant differences in accuracy between the tendencies based method and those that obtain slightly better results. These results are also confirmed in the classification accuracy metrics, with similar results for both datasets. In precision, it is statistically equivalent to RSVD and RSVD2 techniques, and only SVD++ obtains slightly better results. In ROC metric, it is the best together with SVD and SVD++ (there are no statistically significant differences among them). The results for half-life utility are also good, only slightly worst than SVD, regression-based, slope one or integrated model (the last two are statistically equivalent). On the other side, results in recall are modest when compared with PD or bi-polar SO; although it is equivalent to methods with similar precision such as those based on SVD. Under sparsity conditions, it also presents the best results overall, together with some SVD variants. With less than 50% of the data as training set, it clearly outperforms the accuracy and precision of all memory-based approaches. With 10%, high sparsity conditions, it improves the best user-based method by 20%, and by 10% methods such as slope one or item-based. Only RSVD, RSVD2 and SVD++ present equivalent results under sparse conditions. Furthermore, along with personality diagnosis and SVD-based strategies, it is the only one whose coverage practically does not diminish when decreasing matrix density. With a training set containing only 5 ratings per user, it is still able to make predictions for more than 90% of items, while the user-based barely covers 12%, slope one less than 9% and item-based does not even reach 6%.

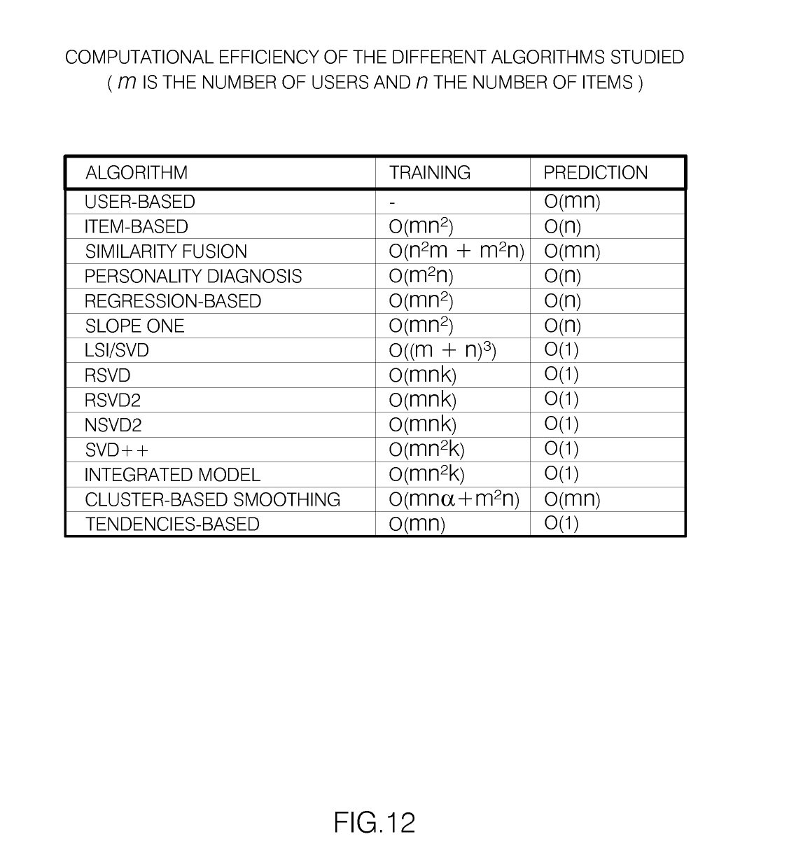

It is with computational efficiency where the tendencies based method obtains the best results. This is very important for recommendation systems that require real-time recommendations. In FIG. 12 the comparison of the computational complexity of the different methods is shown.

Complexity has been separated into two parts, training and prediction, corresponding to the construction of the model using the training data and the computation of a single prediction, respectively. Training only needs to be performed once, while generally, a large number of predictions will be made. Thus, a low complexity when making a prediction can compensate an elevated complexity in training. In general, model-based methods are more efficient when computing a prediction, although the construction of the model has a considerable complexity. The tendencies based method stands out by far as the most efficient, with a complexity of O(mn) in training and of O(1) in the prediction.

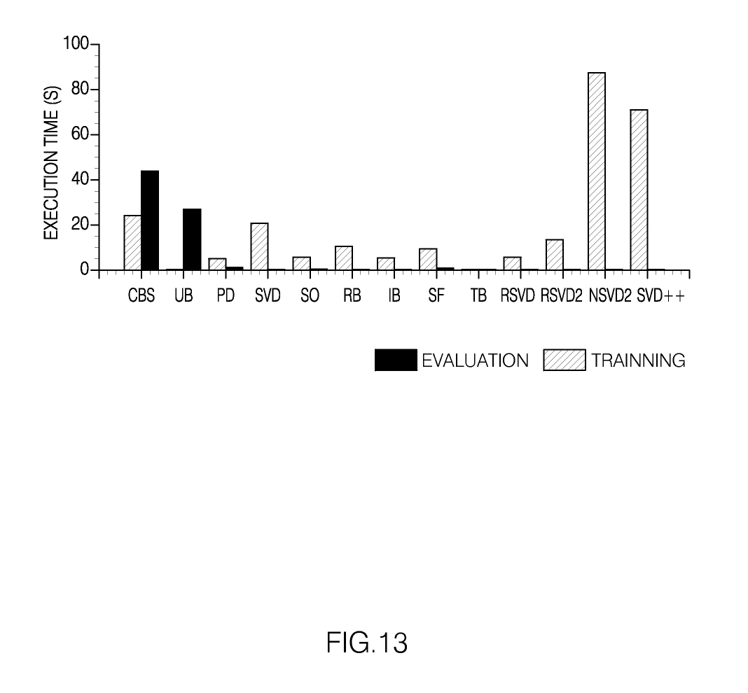

These theoretical results are confirmed by studying the execution times. FIG. 13 shows both the training and evaluation times of several methods for the MovieLens dataset, with a training set of 80%. Evaluation time refers to the time invested in computing the rating prediction for all items in the evaluation set (around 10,000 predictions). As expected, most model-based methods have a low prediction time, although the model construction is rather complex in some cases. Techniques such as SVD++ that have obtained good results with accuracy metrics present a high model construction time. On the other hand, user-based techniques have no training phase, but they need more time to compute a prediction. Among the methods studied, the tendencies based shows, by far, the best results. Its training time, 13.2 ms. in 80% of the MovieLens dataset, is several orders of magnitude better than methods with similar accuracy, such as RSVD (5,433 ms.), RSVD2 (13,198 ms.) or SVD++ (71,025 ms.). At the same time, its prediction time (12 ms.) is similar to that of other model-based approaches and much better than that of methods such as user-based. For Netflix (80% training set), the same great results are obtained: less than 4 s. of training time, much better than RSVD (640 s.), RSVD2 (860 s.) or SVD++ (9,700 s.).

The invention claimed is:

1. A method for recommending one or more items among a plurality of items to a user implemented in a recommendation system including a processor and a memory, said method comprising:
(a) calculating, using said processor, a user profile based on a plurality of previous ratings provided by said user;
(b) calculating, using said processor, an item profile based on a plurality of previous ratings provided by a plurality of other users;
(c) calculating, using said processor, an estimated rating for an item not rated by said user; and
(d) calculating, using said processor, a recommendation of one or more items to said user based on said user profile, said item profile, and said estimated rating.

2. The method of claim 1, wherein said calculating a user profile is based on computing a mean of said previous ratings provided by said user.

3. The method of claim 2, wherein said calculating an item profile is based on computing a mean of said previous ratings provided by said plurality of other users.

4. The method of claim 3, wherein said calculating an user profile further comprises computing a tendency of said previous ratings provided by said user.

5. The method of claim 4, wherein said calculating an item profile further comprises computing a tendency of said previous ratings provided by said plurality of other users.

6. The method of claim 5, wherein said tendency of said previous ratings provided by said plurality of other users is calculated using a User Tendency Calculation Method (UTCM).

7. The method of claim 6, wherein said tendency of said previous ratings provided by said plurality of other users is calculated using an Item Tendency Calculation Method (ITCM).

8. The method of claim 7, wherein said calculating an estimated rating for an item not rated by said user is calculated using a Tendencies Based Collaborative Filtering Method (TBCFM).

9. The method of claim 8, wherein said recommendation of one or more items to said user comprises the steps of:
(a) calculating a plurality of estimated ratings for a plurality of items not rated by said user;
(b) sorting said items not rated by said user according to said estimated ratings; and
(c) selecting and reporting said items with said estimated rating above a threshold.

10. The method of claim 9, wherein said TBCFM comprises calculating a user rating pᵤᵢ, based on a user mean v_{u.}, a user tendency τ_{u.}, an item mean v_{.i}, and an item tendency τ_{.i}, according to pᵤᵢ=max {v_{u.}+τ_{.i},v_{.i}+τ_{u.}} if said user tendency and said item tendency are both greater than or equal to zero.

11. The method of claim 10, wherein said TBCFM further comprises calculating said user rating as pᵤᵢ=min {v_{u.}+τ_{.i},v_{.i}+τ_{u.}} if said user tendency and said item tendency are both less than zero.

12. The method of claim 11, wherein said TBCFM further comprises calculating said user rating as pᵤᵢ=min {max{v_{u.}, (v_{.i}+τ_{u.})β+(v_{u.}+τ_{.i})(1−β)}, v_{.i}} if said user tendency is less than zero and said item tendency is greater than or equal to zero and said item mean is greater than or equal to said user mean.

13. The method of claim 12, wherein said TBCM further comprises calculating a user rating as pᵤᵢ=min {max{v_{.i}, (v_{.i}+τ_{u.})β+(v_{u.}+τ_{.i})(1−β)}, v_{u.}} if said user tendency is greater than or equal to zero and said item tendency is less than zero and said item mean is less than said user mean, and as pᵤᵢ=v_{.i}β+v_{u.}(1−β) in all other cases.

14. A recommendation apparatus for recommending one or more items among a plurality of items to a user, comprising:
(a) a memory to store a plurality of ratings; and
(b) a processor configured for (1) calculating a user profile based on a plurality of previous ratings provided by said user; (2) calculating an item profile based on a plurality of previous ratings provided by a plurality of other users; (3) calculating an estimated rating for an item not rated by said user; and (4) calculating a recommendation of one or more items to said user based on said user profile, said item profile, and said estimated rating.

15. The recommendation apparatus of claim 14, wherein said calculating a user profile is based on computing a mean of said previous ratings provided by said user; said calculating an item profile is based on computing a mean of said previous ratings provided by said plurality of other users; said calculating a user profile comprises computing a tendency of said previous ratings provided by said user; said calculating an item profile comprises computing a tendency of said previous ratings provided by said plurality of other users; said tendency of said previous ratings provided by said plurality of other users is calculated using a User Tendency Calculation Method (UTCM); said tendency of said previous ratings provided by said plurality of other users is calculated using an Item Tendency Calculation Method (ITCM); and said calculating an estimated rating for an item not rated by said user is calculated using a Tendencies Based Collaborative Filtering Method (TBCFM).

16. The recommendation apparatus of claim 15, wherein said recommendation of one or more items to said user comprises the steps of: (a) calculating a plurality of estimated ratings for a plurality of items not rated by said user; (b) sorting said items not rated by said user according to said estimated ratings; and (c) selecting and reporting said items with said estimated rating above a threshold.

17. The recommendation apparatus of claim 16, wherein said TBCFM comprises (a) calculating a user rating pᵤᵢ, based on a user mean v_{u.}, a user tendency τ_{u.}, an item mean v_{.i}, and an item tendency τ_{.i}, according to pᵤᵢ=max {v_{u.}+τ_{.i},v_{.i}+τ_{u.}} if said user tendency and said item tendency are both greater than or equal to zero; (b) calculating said user rating as pᵤᵢ=min {v_{u.}+τ_{.i},v_{.i}+τ_{u.}} if said user tendency and said item tendency are both less than zero; (c) calculating said user rating as pᵤᵢ=min {max{v_{u.}, (v_{.i}+τ_{u.})β+(v_{u.}+τ_{.i})(1−β}, v_{.i}} if said user tendency is less than zero and said item tendency is greater than or equal to zero and said item mean is greater than or equal to said user mean; and (d) calculating a user rating as pᵤᵢ=min {max{v_{.i}, (v_{.i}+τ_{u.})β+(v_{u.}+τ_{.i})(1−β)}, v_{u.}} if said user tendency is greater than or equal to zero and said item tendency is less than zero and said item mean is less than said user mean or as pᵤᵢ=v_{.i}β+v_{u.}(1−β) in all other cases.

18. A non-transitory computer-readable storage medium with an executable program stored thereon to implement a recommendation system, wherein said executable program instructs an apparatus to perform the following steps:
(a) calculating a user profile based on a plurality of previous ratings provided by said user;
(b) calculating an item profile based on a plurality of previous ratings provided by a plurality of other users;
(c) calculating an estimated rating for an item not rated by said user; and
(d) calculating a recommendation of one or more items to said user based on said user profile, said item profile, and said estimated rating.

19. The non-transitory computer-readable storage medium of claim 18, wherein said calculating a user profile is based on computing a mean of said previous ratings provided by said user; said calculating an item profile is based on computing a mean of said previous ratings provided by said plurality of other users; said calculating a user profile comprises computing a tendency of said previous ratings provided by said user; said calculating an item profile comprises computing a tendency of said previous ratings provided by said plurality of other users; said tendency of said previous ratings provided by said plurality of other users is calculated using a User Tendency Calculation Method (UTCM); said tendency of said previous ratings provided by said plurality of other users is calculated using an Item Tendency Calculation Method (ITCM); and said calculating an estimated rating for an item not rated by said user is calculated using a Tendencies Based Collaborative Filtering Method (TBCFM).

20. The non-transitory computer-readable storage medium of claim 19, wherein said TBCFM comprises (a) calculating a user rating pᵤᵢ, based on a user mean v_{u.}, a user tendency τ_{u.}, an item mean v_{.i}, and an item tendency τ_{.i}, according to pᵤᵢ=max {v_{u.}+τ_{.i},v_{.i}+τ_{u.}} if said user tendency and said item tendency are both greater than or equal to zero; (b) calculating said user rating as pᵤᵢ=min {v_{u.}+τ_{.i},v_{.i}+τ_{u.}} if said user tendency and said item tendency are both less than zero; (c) calculating said user rating as pᵤᵢ=min {max{v_{u.}, (v_{.i}+τ_{u.})β+(v_{u.}+τ_{.i})(1−β)}, v_{.i}} if said user tendency is less than zero and said item tendency is greater than or equal to zero and said item mean is greater than or equal to said user mean; and (d) calculating a user rating as pᵤᵢ=min {max{v_{.i}, (v_{.i}+τ_{u.})β+(v_{u.}+τ_{.i})(1−β)}, v_{u.}} if said user tendency is greater than or equal to zero and said item tendency is less than zero and said item mean is less than said user mean, or as pᵤᵢ=v_{.i}β+v_{u.}(1−β) in all other cases.
